(19) United States
(12) Patent Application Publication
(10) Pub. No.: US 2004/0203346 A1
(43) Pub. Date: Oct. 14, 2004

(54) System and method for integrating local-area and wide-area wireless networks

(76) Inventors: John Myhre, Shoreline, WA (US); Venson Shaw, Kirkland, WA (US); David Holmes, Sammamish, WA (US); David K. Smith, Issaquah, WA (US); Brian Daly, Scottsdale, AZ (US); Ileana Leuca, Bellevue, WA (US)

Correspondence Address: DAVIS MUNCK, P.C., 900 Three Galleria Tower, 13155 Noel Road, Dallas, TX, 75240, US

(21) Appl. No.: 10/326,700

(22) Filed: Dec. 20, 2002

Related U.S. Application Data
(60) Provisional application No. 60/420,870, filed on Oct. 24, 2002.

(51) Int. Cl. H04B 7/15; H04Q 7/20

(52) U.S. Cl. 455/11.1; 455/41.1; 455/426.1

(57) ABSTRACT

A system and method for allowing a mobile telephone or mobile terminal to interact with its wireless telephone/data service, including conventional 2G and 3G systems (hereinafter the “wireless network”), and also to interact with local-area services such as WLAN, BlueTooth, and personal area networks, and to communicate with and use systems and peripherals available on those networks. Since the mobile terminal is a trusted device on the wireless network, it also then acts as a gateway to allow other local-area services and devices to connect and communicate with the wireless network.

### CROSS-REFERENCE TO OTHER APPLICATION

This application claims priority from U.S. Provisional Patent Application No. 60/420,870, filed Oct. 24, 2002, which is hereby incorporated by reference.

This application shares at least some common text and figures with, but is otherwise unrelated to, U.S. patent application Ser. No. ______ for “System and Method for Content Delivery Using Alternate Data Paths in a Wireless Network” and U.S. patent application Ser. No. ______ for “System and Method for Delivering Data Services in Integrated Wireless Networks,” both filed concurrently herewith, and both hereby incorporated by reference.

### TECHNICAL FIELD OF THE INVENTION

The present invention is directed, in general, to improved wireless communications, and in particular to a next-generation terminal complex system apparatus and related method allowing device interconnection with cellular and other wireless telephone networks, wireless LAN, BlueTooth, and personal area networks.

### BACKGROUND OF THE INVENTION

Wireless systems are being developed and built to handle both voice communication and data communication. Traditionally, wireless devices such as mobile telephones were primarily used for voice communication between users. However, wireless Internet applications are being developed that increase the demand for wireless data communication in addition to voice communication. Wireless networks have evolved to accommodate more data communication. Generally speaking, the first generation of wireless networks transmitted analog voice signals. The second generation (2G) of wireless networks transmit digital voice communication and some limited data communication. High-speed data communication systems are often referred to as third generation (3G) systems with targeted applications or services including but not limited to wireless multi-media services with different requirements on quality of service. This characterization of first, second and third generation is a general description for use in the introduction of the needs in the related art addressed by the present invention.

FIG. 1 illustrates a common multi-network arrangement 110 faced by many wireless service subscribers. Many wireless carriers utilize either a 2G wireless network 116, 118, 120 or a 3G wireless network 122, 124, 126, 128. In some cases, a wireless carrier will operate both a 2G and 3G network and therefore offer a variety of subscriber services through different networks. A wireless device 112, such as a wireless telephone, mobile terminal, or mobile multi-media device, may communicate with a 2G radio system 116 or a 3G radio system 122. The 2G radio system 116 communicates its voice or data signals to a 2G radio transport network 118 to a publicly switched telephone network (PSTN) 120 for communicating telephone calls and data. The 3G radio system 122 communicates with a circuit switched transport network 124 and then the PSTN 120 for telephone calls and may communicated via a packet switched network 126 with a public packed switched data network 128 for high-speed data signals.

Both 2G and 3G networks may use standard interfaces known in the art. Such interfaces include the SS7 MAP interface for the global system for mobile communication (GSM) and the ANSI-41 interface for time divisional multiple access (TDMA or IS-136) and code division multiple access (CDMA or IS-95). The SS7 MAP interface and ANSI-41 interface generally relate to circuit switched 2G voice/data services. The General Packet Radio Service (GPRS) and Internet Protocol (IP) standard interfaces generally apply to 3G data and multi-media services. Those of ordinary skill in the art understand the operation of these interfaces and the details of their operation are not critical for the present disclosure. Therefore, no more details are provided herein.

In some service areas, both 2G and 3G wireless systems have overlapping coverage. Service requests, i.e., requests for voice, data, e-mail, streaming video, etc., from wireless devices can be satisfied either through a 2G network, 3G network or both networks. When one compares the services offered by the 2G and 3G networks, some applications may only be satisfied at an acceptable level of service through one network. Similarly, some applications or services can be supported on both network. For example, both 2G and 3G networks service voice communication. However, when voice communication is needed, either the 2G or 3G may be better suited at the time of the request for services, based on cost of service, quality of service, or other factors, to process the voice communication.

Presently, there is no process or system for directing specific service requests to any network other than the network on which the wireless device is presently parked.

The mobile communications industry has gone through exponential growth in the recent years. However, it is now facing tremendous market challenge as well as competitive technology impact from wireless LAN (WLAN), such as IEEE 802.11a and 802.11b, and BlueTooth, etc.

Increasingly, specialized wireless devices are being released on the market. These include multifunction cell phones, called generically “mobile terminals,” personal digital assistants (PDAs), laptop and portable computer systems, and others. Typically, each of these devices are designed for use in a specific context, and therefore have a wireless capability that only supports its specific use.

However, due to the continuous change of the functions needed by each end user, the end user would prefer to have a different device at different occasion and different time of the day. For example, the user's needs on a Saturday night would be significantly different from his needs on Monday morning at work. Subsequently, a single device would not work and a flexible device environment that can be changed to accommodate the surrounding environment at that time becomes important to the user.

Another disadvantage for a single, unified device is that the user must depend on it all the time, and does not have the option to choose a different device while situation and requirement changes and the functionality is not readily available on the device. This results in customer inconvenience and dissatisfaction.

A further disadvantage for a single multifunction device is that user requirements may be different, and therefore a single device that comes with universal functionalities may be rich in features, but may not be sufficiently customized or optimized to meet the individual's requirements. These devices may be adequate for most of their functions but are not typically optimized for more than one function.

Moreover, current multifunction devices can only connect to one type of wireless service. Since a specific service type may only be optimal for a specific function, other functions are only able to access a non-optimal service.

It should be noted that, due to the continuous change of the need for individual end user, end users often prefer to have a different device at different occasions and perhaps for different times of the day. For example, the need for Saturday night, when social functions or family sharing may be more important, would be significantly different than from Monday morning, when business, work, or productivity is more important.

Subsequently, a single device often cannot work to meet such flexible device requirements as time and situation changes.

An additional consideration is the use and access to peripheral devices. In current network topologies, many different peripheral devices, including printers, scanners, audio devices, and other multimedia devices, are connected to WLANs, but are only available to pre-configured members of the WLAN. Moreover, their peripheral devices typically cannot communicate over the wireless, cellular, or Bluetooth networks.

It would be desirable to provide a system, method, and means for a user of a mobile terminal or telephone to interact with local WLAN and Bluetooth networks, and to take advantage of other devices connected to those networks.

### SUMMARY OF THE INVENTION

To address the above-discussed deficiencies of the prior art, it is a primary object of the present invention to provide a system and method for improved wireless communications, and to provide a next-generation terminal complex system apparatus and related method allowing device interconnection with cellular and other wireless telephone networks, wireless local area networks (WLAN), BlueTooth, and personal area networks, as described more fully in the detailed description below.

The preferred embodiment of the present invention provides a system and method for allowing a mobile telephone or mobile terminal to interact with its wireless telephone/data service, including conventional 2G and 3G systems (hereinafter the “wireless network”), and also to interact with local-area services such as WLAN, BlueTooth, and personal area networks, and to communicate with and use systems and peripherals available on those networks. Since the mobile terminal is a trusted device on the wireless network, it also then acts as a gateway to allow other local-area services and devices to connect and communicate with the wireless network.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a wireless network system;

FIG. 2 depicts a block diagram of a mobile terminal operating within multiple wireless networks, in accordance with a preferred embodiment of the present invention;

FIG. 3 depicts a flowchart of a process in accordance with a preferred embodiment of the present invention;

FIG. 4 depicts a flowchart of a process in accordance with a preferred embodiment of the present invention;

FIG. 5 depicts a flowchart of a process in accordance with a preferred embodiment of the present invention; and

FIG. 6 depicts a flowchart of a process in accordance with a preferred embodiment of the present invention.

### DETAILED DESCRIPTION OF THE INVENTION

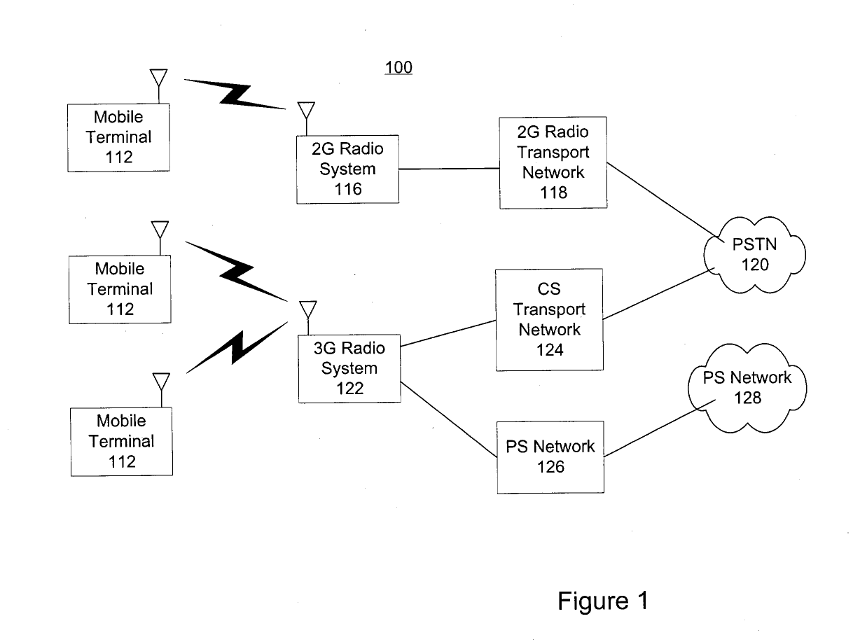

FIGS. 1 through 6 and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The preferred embodiment of the present invention provides a system and method for allowing a mobile telephone or mobile terminal to interact with its wireless telephone/data service, including conventional 2G and 3G systems (hereinafter the “wireless network”), and also to interact with local-area services such as WLAN, BlueTooth, and personal area networks, and to communicate with and use systems and peripherals available on those networks. Since the mobile terminal is a trusted device on the wireless network, it also then acts as a gateway to allow other local-area services and devices to connect and communicate with the wireless network.

Definitions. Following are short definitions of the usual meanings of some of the technical terms and abbreviations which are used in the present application. (However, those of ordinary skill will recognize whether the context requires a different meaning.) Additional definitions can be found in the standard technical dictionaries and journals.

UE—User Equipment

UICC—USIM Integrated Circuit Card

USIM/SIM—Universal Subscriber Identity Module; a USIM/SIM is a card used to identify a wireless user, and can be interchanged between wireless devices.

ME—Mobile Equipment

MT—Mobile Terminal

TE—Terminal Equipment

CS Domain—Circuit-switched domain; the standard public service telephone network and legacy cellular telephone network.

PS Domain—Packet-switched domain; services using packet-switched data for wireless and wired communications.

WLAN—Wireless LAN; a local area network that transmits over the air typically in an unlicensed frequency such as the 2.4 GHz band. A wireless LAN does not require lining up devices for line-of-sight transmission. Wireless access points (base stations) are connected to an Ethernet hub or server and transmit a radio frequency over an area of several hundred to a thousand feet and can penetrate walls and other nonmetal barriers. Roaming users can be handed off from one access point to another like a cellular phone system. Laptops use wireless modems that plug into an existing Ethernet port or that are self contained on PC cards, while standalone desktops and servers use plug-in cards (ISA, PCI, and so on). Typical WLAN protocols comply with IEEE 802.X standards.

Bluetooth—A Wireless personal area network (PAN) standard geared for home and office; uses 2.4GHz band at 720 kbps within 30-foot range. Bluetooth is a small form factor, low-cost, short-range wireless technology for interconnecting mobile terminals, mobile PCs, other portable devices and computing peripherals. Bluetooth enables users to connect a wide range of devices without cables. “Bluetooth” is a trademark owned by Telefonaktielbolaget L M Ericsson, Sweden.

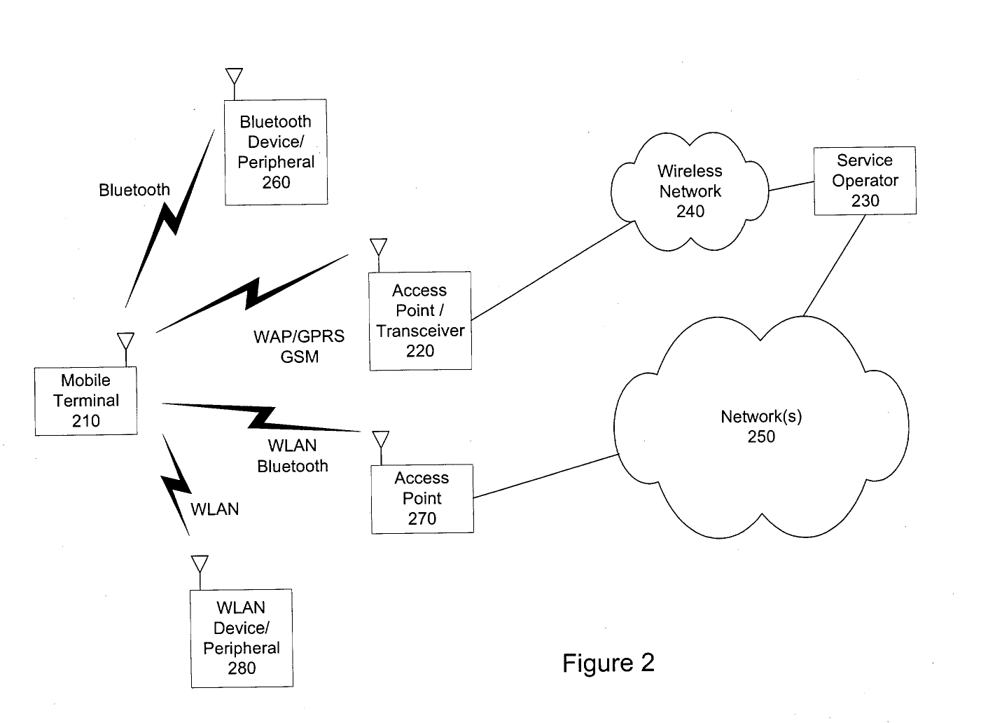

FIG. 2 shows an overview of a multi-network system 200, according to several embodiments of the present invention. Multi-network system 200 includes a mobile terminal 210 operated by a user and a service operator(s) 230 for providing services to the user. Mobile terminal 210 and service operator 230 communicate with each other across wireless network 240. A radio transceiver 220 provides an access point to enable the user to conduct communications across wireless network 240. Wireless network may be a TDMA, CDMA, 2G, 3G, GPRS, or other wireless network.

The mobile terminal 210 may also communicate with network(s) 250 via transceiver 220, wireless network 240, and service operator 230. Network(s) 250 may be a local area network(s) (LAN), wide area network(s) (WAN), the Internet, wireless network(s) or a combination thereof. Radio transceiver 220 may be, for example, a radio tower, a general packet radio service (GPRS) access point, a general system for mobile communications (GSM) access point, a 2G or 3G wireless access point, or a fixed position wireless device implementing the Bluetooth standard.

Mobile terminal 210 may be any computerized system with communication means by which to conduct wire and wireless communications with other parties, such as service operator 230. In various embodiments, mobile terminal 210 may take the form of computer system or a mobile wireless device configured to perform the methods and processes discussed herein. For example, mobile terminal 210 may be a cellular phone, personal digital assistant (PDA), portable computer, handheld device, etc.

A wireless user device can employ a software product containing components to implement a WAP Client thereon. These components include a Wireless Markup Language (WML) Browser, WMLScript engine, Push Subsystem, and Wireless Protocol Stack. Application programs stored in the wireless user device interact with the WAP Client to implement a variety of communications applications.

The WAP Client includes the wireless Public Key infrastructure (PKI) feature, providing the infrastructure and the procedures required for authentication and digital signatures for servers and mobile clients. Wireless PKI is a certificate-based system that utilizes public/private key pairs associated with each party involved in a mobile transaction. Wireless Identity Module (WIM) is a security token feature of the WAP Client, which includes security features, such as public and private keys and service certificates, needed for user authentication and digital signatures. Additionally, it has the ability to perform cryptographical operations to encrypt and decrypt messages.

The types of wireless networks supported by the WAP standard include Cellular Digital Packet Data (CDPD), Code-Division Multiple Access (CDMA), Global System for Mobile Communication (GSM), Time Division Multiple Access (TDMA), GPRS, 3G-Broadband, and the like.

Service operator 230 may be any computerized system with communication means by which to conduct wire and wireless communications with other parties, such as mobile terminal 210. In various embodiments, service operator 230 may take the form of a server or computer system or a fixed or mobile wireless device configured to perform the methods and processes discussed herein. For example, service operator 230 may be a server of a retailer or a cellular phone, personal digital assistant (PDA), portable computer, handheld device, etc.

As shown in FIG. 2, mobile terminal 210 may conduct communications with service operator 230 using Bluetooth technology or general packet radio service (GPRS) or general system for mobile communications (GSM) or other wireless network communications, or can conduct communications with a Bluetooth device or peripheral 260 using Bluetooth technology or the like to establish a personal area network (PAN).

Further, mobile terminal 210 may conduct communications with service operator 230 using a wireless LAN (WLAN) access point which is connected to network(s) 250 by conventional wired or wireless means. Mobile terminal 210 can also connect to WLAN device or peripheral 280 using WLAN protocols.

Therefore, as shown in the embodiment of FIG. 2, the terminal environment has evolved from a traditional and simplistic cellphone-centric system environment into a nontraditional and much more complex environment in which a PDA, laptop, or other wireless devices can now all be interconnected together through the mobile terminal using WLAN, BlueTooth, etc. Therefore multiple devices, each with distinct functionality and resource advantages and limitations, are be able to share and complement with each other via Wireless LAN and BlueTooth, etc.

Instead of receiving application and services solely via the traditional cellular access network, users now have the option to download or receive the same application and services from the public Internet via a WLAN access network infrastructure.

Further, according to disclosed embodiments, mobile terminal 210 is a trusted device on wireless network 240. Mobile terminal is authenticated by service operator 230 to access wireless network 240 and transceiver 220 by any conventional means, such as electronic serial number, USIM/SIM card, or other means. According this embodiment, mobile terminal 210 can then act as a gateway to allow other local-area devices and peripherals, such as WLAN device/peripheral 280 and Bluetooth device/peripheral 260, to access the wireless network 240. Once connected to wireless network 240, these devices can connect through service operator 230 to network(s) 250. Even if these devices already can connect to network(s) 250 through access point 270, this provides an alternate access path to networks 250 for these peripherals.

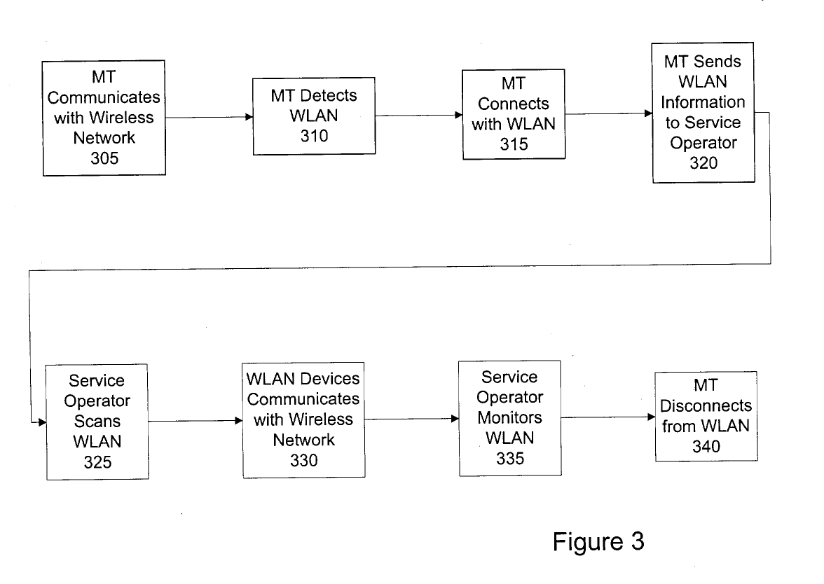

FIG. 3 is a flowchart of a process according to a preferred embodiment. As the mobile terminal operates, it is in substantially constant communication with the service operator over the wireless network (step 305). As the user travels in to an area served by another wireless device or network, it will detect these devices and networks (step 310). These devices, as described above, may be WLAN, Bluetooth, or other-protocol wireless devices, networks, and peripherals, but will be referred to with relation to FIG. 3 as WLAN devices and peripherals, to simplify the following description.

After the mobile terminal has detected a WLAN, it will connect to the WLAN using an appropriate authentication protocol (step 315), then will send information regarding the WLAN to the service operator (step 320). The service operator will then scan the WLAN through the mobile terminal, and will build a profile of the WLAN and accessible devices and peripherals (step 325).

Thereafter, the service operator can communicate with the WLAN network and devices using the mobile terminal as a gateway. Similarly, the WLAN network and devices can communicate with the wireless network, according to the access permitted by the service operator (step 330).

While the mobile terminal remains connected to the WLAN, the service operator will continue to monitor the WLAN network and devices to detect any changes in the available hardware (step 335). Finally, when the user takes the mobile terminal outside the range of the WLAN, the mobile terminal will disconnect from the WLAN and the service operator will update its profile accordingly (step 340).

Current WLAN and BlueTooth protocols only come with a low level protocol (i.e., physical and link layer) support to facilitate access of the application and content from public internet. According to a preferred embodiment, the service operator can now provide and deliver applications and content from a server inside the operator's network, and the network can then work within the complex terminal environment to establish, terminate, and seamlessly reselect the streaming and conversational bearer, to provide an optimal connection to the user. Consequently, high level protocol support such as QoS (Quality of Service) becomes extremely desirable to facilitate end to end negotiation and application content delivery.

Furthermore, high level protocols supporting streaming and/or conversational bearer further allow the improvement of user experience and or service diversity. For example, these protocols allow built-in QoS support for delivering alternative access network paths, alternative receiving device and/or user interfaces, and afford consistent user experience and procedures for authenticating and authorizing the usage of the access network as well as peripheral devices.

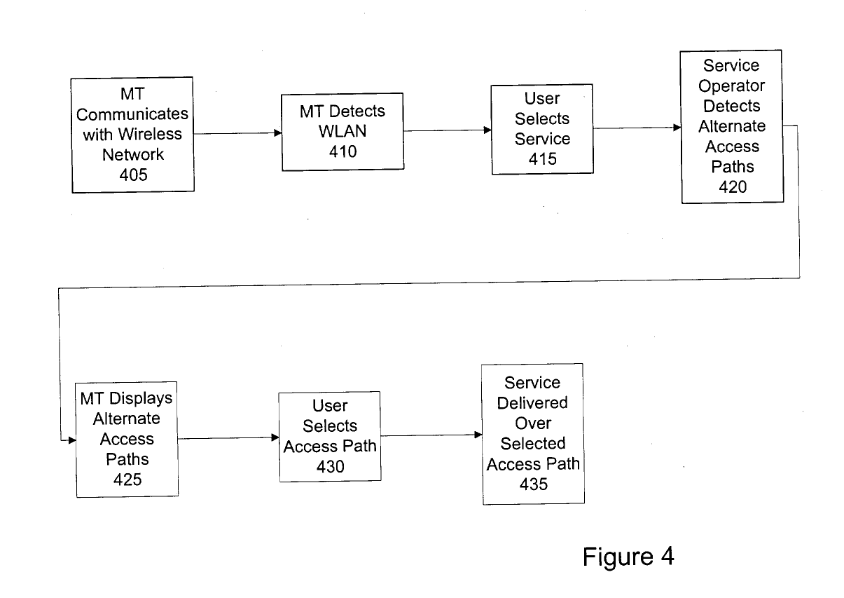

Therefore, additional features of the present embodiment include access diversity and service diversity capabilities. FIG. 4 shows a flowchart of a process for exploiting access diversity, in accordance with a preferred embodiment. According to this process, as described above, the mobile terminal, already connected to the wireless network, will detect and connect to a WLAN, Bluetooth network, or other local-area network, which will be hereafter simply referred to as a WLAN (step 405). The service operator will then detect the properties of the WLAN, including access to the internet or other wide-area networks or services (step 410). Thereafter, when the user of the mobile terminal selects a service, such as short-message-service, email, or voice communications (and many others) (step 415), the service operator will determine if the service can be provided to the user by an access path other than over the wireless network (step 420).

The service operator will then inform the user, via the mobile terminal, of the alternate access paths, optionally including a recommendation as to the best access path (step 425). The user will select his preferred access path (step 430), and the service will then be delivered to or accessed by the user over the selected access path (step 435). In this way, the user can take advantage of access options provided by local-area networks, to receive services in the most efficient manner, according to the user's preferences.

In a similar manner, a device on the local-area network can use the mobile terminal as a gateway to access the wireless network, and thereby use the more-efficient data path as between the local-area network and the wireless network for services to be delivered to the device. If the data path via the wireless network is chosen, the service is delivered from the wireless network to the mobile terminal, then from the mobile terminal to the device over the WLAN.

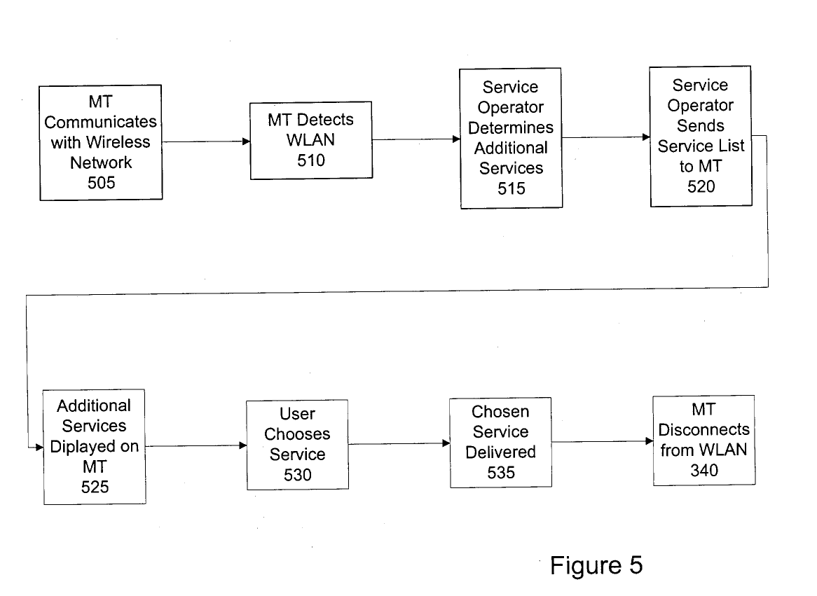

FIG. 5 shows a flowchart for determining a user's service diversity options, according to a preferred embodiment of the present invention. According to this process, as described above, the mobile terminal, already connected to the wireless network, will detect and connect to a WLAN, Bluetooth network, or other local-area network, which will be hereafter simply referred to as a WLAN (step 505). The service operator will then detect the properties of the WLAN, including access to the internet or other wide-area networks or services, and any other accessible devices connected to the WLAN (step 510). After doing so, the service provider will determine what additional services are available to the user, according to the WLAN-accessible devices and services accessible to the user (step 515). For example, a device on the WLAN can be capable of producing sound or music that the mobile terminal cannot; the service operator can detect and exploit this capability.

The service operator will then download a list of the additional services to the mobile terminal (step 520). The additional services are then displayed to the user on the mobile terminal (step 525), and the user will choose a service (step 530). Finally, the chosen additional service is delivered to the user on the appropriate WLAN device(s) (step 535).

In the circuit-switched (CS) domain, there is typically monolithic user equipment with transparent peripherals. The Bluetooth handsfree profile standardizes an application layer relationship between the call control on the CS phone and an application in an external device. In this case, the phone/mobile terminal essentially acts as an application layer gateway.

In the packet-switched (PS) domain, however, the mobile terminal acts as a radio and PS control plane. The terminal equipment includes an internet protocol (IP) stack and applications. Typically, all IP traffic is sub-network multiplexed through the mobile terminal. Multiple IP addresses are supported via multiple distinct contexts. Further, in the PS domain, no IP networking is supported between terminal equipment.

A conventional single-device approach provides that a cell phone will continue to integrate and include more functionality from a PDA, laptop, etc. However, it is known that such an approach imposes severe system complexity and additional hardware cost, increases power consumption, and drives the manufacturing cost prohibitively high, making such combination telephone device difficult, if not impossible, to launch and receive broad market acceptance.

One challenge for complex terminal environments with alternative access paths is to allow consistent user experience. This consequently provides the maximum opportunity for cellular access network operator to further migrate into a more integrated operator/service provider environment that leverages the access diversity feature. That is, a service or application can be accessed via either the cellular network, WLAN or Bluetooth, and deliver consistent user experience to the end user.

A preferred embodiment a terminal complex system that allows the cell phone to be flexibly interconnected with the surrounding peripheral devices, leveraging WLAN, BlueTooth, or other wireless protocols. The disclosed system further allows the cell phone to selectively augment its functionality through interconnecting with the surrounding peripheral devices in order to meet user requirements on demand, and further allows the user to change and select the surrounding peripheral devices to which he wishes to connect to make full use of the surrounding device functionalities.

In this way, the user can access an appropriate device to provide optimal delivery of any required function, instead of having to rely on a single device to provide all possible functions. Further, by allowing the user to choose between wireless services, the preferred embodiments allow the service delivery to by optimized both by service type and device type.

Since a mobile phone is essentially used for voice applications and for CS and PS domain data application, it is conceivable a new service launching pad is needed for the next generation IP multimedia services.

In order to provide a consistent user experience or user procedure, it is necessary to have an authentication method that allows the multiple device being authenticated by the network through a challenge-response mechanism. Such an authentication method is necessary in order to fulfill a service request and to perform service delivery. The objective of such generalized authentication method is to allow the PDA, laptop or any terminal device to perform the same user procedure in order to provision the device and the network elements for service delivery.

A preferred embodiment of the present invention provides a complex terminal environment that allows an alternative access path and consistent user experience. This enables the maximum opportunity for cellular access network operator to further migrate into the more integrated operator/service provider environment that that leverage the access diversity feature, i.e., a service or application can either access via cellular network or WLAN and to deliver consistent user experience to the end user.

The current WLAN and BlueTooth only come with low level protocol (i.e., physical and link layer) support to facilitate access of the application and content from public internet.

It is preferred that, provided the operator can now provide and deliver the application and content from a server inside the operator's network, the network can then work with for the complex terminal environment to establish, terminate, and seamlessly reselect the streaming and conversational bearer. Consequently, high level protocol support such as QoS (Quality of Service) becomes extremely desirable to facilitate end to end negotiation and application content delivery.

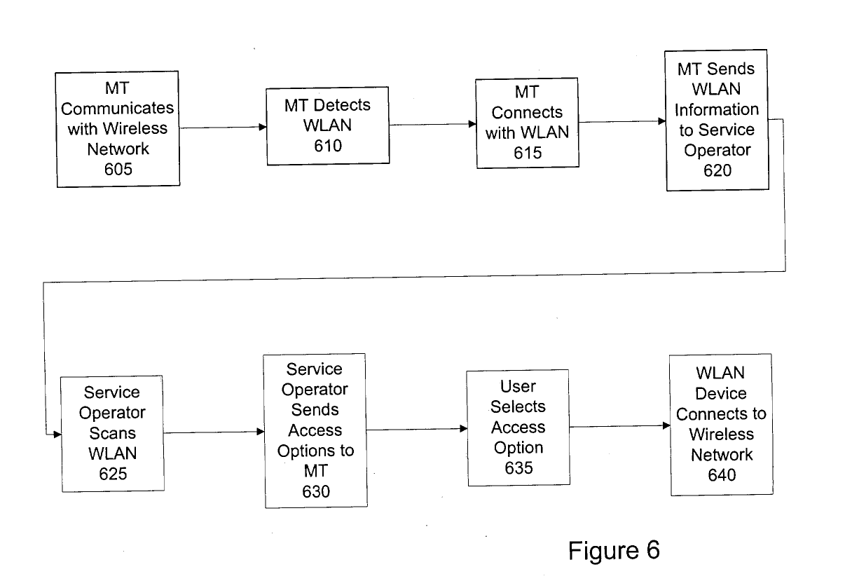

FIG. 6 is a flowchart of a process according to a preferred embodiment. As the mobile terminal operates, it is in substantially constant communication with the service operator over the wireless network (step 605). As the user travels in to an area served by another wireless device or network, it will detect these devices and networks (step 610). These devices, as described above, may be WLAN, Bluetooth, or other-protocol wireless devices, networks, and peripherals, but will be referred to with relation to FIG. 6 as WLAN devices and peripherals, to simplify the following description.

After the mobile terminal has detected a WLAN, it will connect to the WLAN using an appropriate authentication protocol (step 615), then will send information regarding the WLAN to the service operator (step 620). The service operator will then scan the WLAN through the mobile terminal, and will build a profile of the WLAN and accessible devices and peripherals (step 625).

Thereafter, the service operator will download a list of access options to the mobile terminal for the user's review (step 630). These can include options wherein a device on the WLAN will achieve a higher QoS by connecting to the wireless network using the movable terminal as a gateway.

The user will select an access option on the mobile terminal, to allow a local-area device on the WLAN to connect to the wireless network (step 635). The service operator will then authorize that communication, and will authenticate the corresponding WLAN device to connect to the wireless network, using the mobile terminal as a gateway (step 640).

In summary, a preferred embodiment includes a complex terminal system that leverages BlueTooth, WLAN, and/or conventional wireless telephone networks. This embodiment next allows the selective provisioning of the device configuration in order to support service requests and service delivery. Various embodiments further support consistent user experience leveraging a generalized authentication method. This embodiment further allows access diversity and device diversity to provide the best user experience.

The disclosed embodiments allow cellular operators and service providers to leverage the capabilities of these nontraditional terminal devices (i..e., PDA, laptop, intelligent appliances, etc.) and non-traditional access network (i.e., WLAN, BlueTooth) to deliver novel applications and services.

Some of the advantages of embodiments disclosed herein include the ability to further expand the terminal system configuration into the complex systems environment leveraging WLAN, BT, etc. The complex terminal system allows users to share functionality and resource among multiple devices and peripherals. The disclosed system allows alternative access for either cellular or WLAN access as per application, content, network, or user requirements or demands. Further, the system manages and maintains a consistent user experience and user procedure as the network authenticates and provisions the individual devices prior to or during application service delivery.

The mobile terminal leverages BlueTooth support to access peripheral devices and subsequently allow the peripheral devices to perform call control functions; to access peripheral devices and subsequently leveraging peripheral device capability to improve the user interface; to access peripheral devices and subsequently leverage peripheral device capability to deliver multimedia massaging, e.g., the ability to use a video camera to capture a still image and deliver the image via SMS to a server via email client and a WAP browser.

The preferred embodiments also provide such advantages as developing a differentiated WLAN strategy beyond the traditional access network approach; using MMS to explore more powerful multimedia services leveraging streaming and/or conversational bearer; facilitating the interaction between the network and the terminal system in order to deliver consistent user experience, device diversity, as well as access diversity; allowing commercial use of complex terminal environment and further launch advanced IP multimedia services leveraging streaming and/or conversational bearer and alternative access through WLAN and BlueTooth.

Additional reference material is widely available, including Bluetooth standard specifications (available, as of the filing date of this application, at http://www.bluetooth.com/dev/specifications.asp), which is hereby incorporated by reference. Wireless LAN standards are available, as of the filing date of this application, at http://standards.ieee.org/catalog/olis/lanman.html, and are hereby incorporated by reference.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A mobile terminal, comprising:
circuitry for connecting to a wide-area wireless network system and communicating with a first device on the wide-area wireless network system, wherein the mobile terminal is a trusted device on the wide-area wireless network;
circuitry for connecting to a local-area wireless network system and communicating with a second device on the local-area wireless network system; and
means for allowing the first device to communicate with the second device, using the mobile terminal as a gateway between the wire-area wireless system and the local-area wireless system.

2. The mobile terminal of claim 1, wherein the wide-area wireless network system is a mobile telephone network.

3. The mobile terminal of claim 1, wherein the wide-area wireless network system is a GPRS network.

4. The mobile terminal of claim 1, wherein the wide-area wireless network system is a cellular packet-switched network.

5. The mobile terminal of claim 1, wherein the local-area wireless network system is a WLAN network.

6. The mobile terminal of claim 1, wherein the local-area wireless network system is a Bluetooth network.

7. The mobile terminal of claim 1, wherein the local-area wireless network system comprises only the second device.

8. The mobile terminal of claim 1, wherein the mobile terminal is a mobile telephone handset.

9. The mobile terminal of claim 1, wherein the mobile terminal is a mobile data processing system.

10. The mobile terminal of claim 1, further comprising means for authenticating the second device.

11. A method for data communications, comprising:
communicating, in a wide-area wireless network, with a mobile terminal;
receiving, from the mobile terminal, data identifying at least one local-area wireless device that is communicating with the mobile terminal;
storing a profile corresponding to the local-area wireless device; and
authorizing the local-area wireless device to communicate with the wide-area wireless network via the mobile terminal, wherein the mobile terminal acts as a gateway between the local-area wireless device and the wide-area wireless network.

12. The method of claim 11, further comprising authenticating the local-area wireless device by the mobile terminal.

13. The method of claim 11, wherein the wide-area wireless network system is a mobile telephone network.

14. The method of claim 11, wherein the wide-area wireless network system is a GPRS network.

15. The method of claim 11, wherein the wide-area wireless network system is a cellular packet-switched network.

16. The method of claim 11, wherein the local-area wireless network system is a WLAN network.

17. The method of claim 11, wherein the local-area wireless network system is a Bluetooth network.

18. The method of claim 11, wherein the mobile terminal is a mobile telephone handset.

19. The method of claim 11, wherein the mobile terminal is a mobile data processing system.

20. The method of claim 11, further comprising receiving a user selection before authorizing the local-area wireless device.
